(19) United States
(12) Patent Application Publication
(10) Pub. No.: US 2005/0212687 A1
(43) Pub. Date: Sep. 29, 2005

(54) Control system, controlling device, control method, and program

(75) Inventor: Natsuko Nishikata, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/038,186

(22) Filed: Jan. 21, 2005

(30) Foreign Application Priority Data
Jan. 20, 2004 (JP) 2004-011979

(51) Int. Cl. G08C 19/00

(52) U.S. Cl. 340/825.72; 340/3.1; 348/734

(57) ABSTRACT

The present invention is intended to solve troubles caused by an AV system that is supposed to be operated on the basis of one-to-one relationship between a base station device and a monitor devise. When the AV system constituting one base station device and a plurality of monitor devices is used, the problem, which is caused by the each monitor device capable of controlling the base station device, may be encountered. The right of control is given to only one particular monitor device at a time among a plurality of monitor devices. The monitor device is set whether or not it will function as master as the right of control. When the monitor device requests the transmission/reception of a control command for controlling the base station device, a command sender/receiver middleware of this monitor device executes the transmission/reception of a control command in response to this request only when the monitor device is set to master. This novel configuration allows only the monitor device set to master to control the base station device.

### BACKGROUND OF THE INVENTION

The present invention relates to a control system composed of a controlling device and a controlled device and the controlling device constituting this control system. The present invention also relates to a control method that is applied to this controlling device and a program that is executed by thereby.

The applicant hereof proposed, as an AV (Audio Video) system for example, a configuration in which a base station device and a monitor device are interconnected by wireless communication.

The base station device of this AV system is equipped with a television broadcast tuner for example so as to selectively receive television broadcast signal and demodulate it into audio/video signals. The base station device also has audio/video signal input terminals, thereby having external audio/video source input capabilities. The audio/video information thus obtained can be converted into a form of audio/video data encoded for compression that is transmittably outputted in a wireless manner, for example.

The base station device is also equipped with a device and a modem that are compliant with Ethernet (trademark), thereby having the ability to connect to a network, such as the Internet. In addition, the base station device is equipped with browser capabilities of displaying, in images, Web site data received via the Internet as well as electronic mail capabilities for example, thereby transmittably outputting the browser image information obtained by the browser capabilities and the display data of mail applications as compressed video data.

A monitor device has a size small enough for allowing the user to carry inside the room for example. The monitor device decodes the audio/video data supplied from the base station device in a wireless manner, thereby displaying images and outputting sound.

The various operations for controlling base station devices, such as the tuning of television stations and the selection of audio/video sources, can be executed from the monitor device. The operational information is transmitted to each base station devices. In accordance with the received operational information, each base station device executes control on the tuner for channel switching and audio/video source input switching.

The operations associated with browser screen and mail can also be executed from the monitor device. The operational information is transmitted to each base station device. In response to the received operational information, each base station device executes browser and mail applications. This configuration allows the AV system to execute Internet browsing and mailing.

With such AV system, the user can carry the monitor device around the room for example to set it at a desired place in the room. As long as the monitor device is within a communicable range, the user can view television programs and such content as audio/video information that is inputted in the base station device, anywhere in the room.

Currently, this AV system is provided to the user in a configuration based on a pair of base station device and monitor device. The configuration of this AV system is schematically illustrated in FIG. 12, in which audio/video data is transmitted from a base station device 1 to a monitor device 2 in wireless communication. Also, as described above, in response to such operations executed from the monitor device 2 as the channel switching by the tuner and the operation of Internet applications, commands are transferred between the monitor device 2 and the base station device 1 for example and the base station device 1 accordingly executes predetermined operations. Conceptually, The output of control information from the monitor device 2 through wireless communication can control the operation of the base station device 1.

[Patent Document 1]

Japanese Patent Laid-open No. Hei 7-298368

Now, it is supposed here with respect to an actual use of such AV system as described above that it be demonstrated at shops for example. The demonstration would be more effective if the monitor device by which the user actually views and operates audio/video content is arranged in the plural. In this case, if the same audio/video data is to be outputted on the plurality of monitor devices, only one base station device may be arranged to transmit audio/video data to these monitors. The AV system described so far may be configured that a plurality of monitor devices and one base station device are combined depending on use.

In the above-mentioned case, however, an AV system configuration made up of one base station device and a plurality of monitor devices based on the one-to-one connection between base station device and monitor device presents following problems.

Referring to FIG. 13, there is shown an AV system made up of one base station device 1 and a plurality of monitor devices 2-1 through 2-n. If, in such a system, the audio/video data to be outputted to each of the monitor devices 2-1 through 2-n may be the same, the base station device 1 may be configured in a multicast manner, thereby simultaneously transmitting the same audio/video data to the monitor devices 2-1 through 2-n.

On the other hand, because control of the base station device 1 by the monitor device 2 is based on the one-to-one relationship of the monitor device 2 and the base station device 1, each of the monitor devices 2-1 through 2-n is configured so as to be able to transmit control commands. Therefore, all monitor devices 2 can control the base station device 1.

If this configuration is applied to the above-mentioned demonstration in which monitor devices are arranged at the store for example, the following problems will be encountered. It is supposed here that prospective customers use a plurality of monitor devices 2 on exhibit on a trial basis. In this case, if these customers operate these monitor devices at the same time, the base station device 1 is controlled in accordance with these operations. To be more specific, if a customer using one of the monitor devices performs an operation for television channel switching, the base station device 1 accordingly executes television channel switching and transmits the audio/video data of the selected channel to each of the monitor devices 2-1 through 2-n. This means for example that, for a customer using another monitor device 2, the television channel being outputted as the audio/video data from the monitor device 2 is suddenly changed without own operation, thereby unnecessarily creating confusion.

An AV system, such as described above, made up of one base station device and a plurality of monitor devices, where all of these monitor devices can control their common base station device, presents the above-mentioned problems and the problems in terms of the use of the system.

### SUMMARY OF THE INVENTION

It is therefore an object of the present invention to solve the above-mentioned problems in an AV system made up of one base station device and a plurality of monitor devices.

In carrying out the invention and according to one aspect thereof, a control system has a following construction. The control system includes one controlled device and a plurality of controlling devices. Further, the control system includes communication means for execution communication between the controlled device and one of the plurality of controlling devices, control command sender/receiver means for executing control command transmission/reception by use of the communication means in order to control the controlled device by one of the plurality of controlling device, request means for requesting the control command sender/receiver means for predetermined execution of the control command transmission/reception, and setting means for setting control right to a particular one of the plurality of controlling devices. The control system includes command sender/receiver control means for, if the particular one of the plurality of controlling devices is set to have control right, executing the control command transmission/reception by the control command sender/receiver means in response to the request by the request means and, if the particular one of the plurality of controlling devices is not set to have control right, not executing the control command transmission/reception by the control command sender/receiver means in response to the request by the request means.

In carrying out the invention and according to another aspect thereof, a control system includes: communication means for execution communication between the controlled device and one of the plurality of controlling devices; control command sender/receiver means for executing control command transmission/reception by use of the communication means in order to control the controlled device by one of the plurality of controlling device; request means for requesting the control command sender/receiver means for predetermined execution of the control command transmission/reception; setting means for setting control right to a particular one of the plurality of controlling devices; and command sender/receiver control means for, if the particular one of the plurality of controlling devices is set to have control right, executing the control command transmission/reception by the control command sender/receiver means in response to the request by the request means and, if the particular one of the plurality of controlling devices is not set to have control right, not executing the control command transmission/reception by the control command sender/receiver means in response to the request by the request means.

In carrying out the invention and according to still another aspect thereof, a control method includes the steps of: executing control command transmission/reception with a controlled device for controlling a controlled device; requesting the control command transmission/reception step for predetermined processing of the control command transmission/reception; setting control right to a particular one of a plurality of controlling devices that forms a pair with the controlled device; and executing command transmission/reception control for, if control right is set by the setting step, the control command transmission/reception by the control command transmission/reception step in response to the request by the request step, and not executing, if control right is not set by the setting step, the control command transmission/reception by the control command transmission/reception step in response to the request by the request step.

In carrying out the invention and according to yet another aspect thereof, a program includes for making a controlling device execute the steps of: executing control command transmission/reception with a controlled device for controlling a controlled device; requesting the control command transmission/reception step for predetermined processing of the control command transmission/reception; setting control right to a particular one of a plurality of controlling devices that forms a pair with the controlled device; and executing command transmission/reception control for, if control right is set by the setting step, the control command transmission/reception by the control command transmission/reception step in response to the request by the request step, and not executing, if control right is not set by the setting step, the control command transmission/reception by the control command transmission/reception step in response to the request by the request step.

Each of the above-mentioned configurations is supposed to make a system configuration consisting of one controlled device and a plurality of controlling devices. On thus supposition, the right of control is given to only one particular controlling device of the plurality of controlling devices and the right of control is set to that particular controlling device. When any of the controlling devices requests the transmission/reception of a control command for controlling the controlled device, the control command transmission/reception is executed only with the controlling device given with the right of control, thereby controlling the controlled device.

As described and according to the invention, in configuring a system consisting of one controlled device and a plurality of controlling devices, the right of control is set or not set to each of these controlling devices in advance. Subsequently, only the controlling device given the right of control can control the controlled device. Consequently, troubles that may be caused in the actual use of a system consisting of one controlled device and a plurality of controlling devices can be overcome, thereby realizing the smooth use of such system.

### BRIEF DESCRIPTION OF THE DRAWINGS

These and other objects of the invention will be seen by reference to the description, taken in connection with the accompanying drawing, in which:

FIG. 1 is a schematic diagram illustrating a basic configuration of an AV system practiced as one embodiment of the invention;

FIG. 2 is a schematic diagram illustrating system operations characteristic to the above-mentioned AV system;

FIG. 3 is a block diagram illustrating internal configurations of a base station device and a monitor device that constitute the above-mentioned AV system;

FIG. 4 illustrates procedures of transmission/reception of commands between the monitor device and the base station device for controlling channel switching;

FIG. 5 is a schematic diagram illustrating a structure of middleware associated with the transmission/reception of commands in a monitor device practiced as another embodiment of the invention;

FIG. 6 is a diagram illustrating a structure of a command that is transmitted/received between the monitor device and the base station device;

FIG. 7 is a flowchart indicative of command sender processing that is executed by the monitor device;

FIG. 8 is a flowchart indicative of command receiver processing that is executed by the base station device;

FIG. 9 is a flowchart indicative of master determination processing that is executed by the base station device;

FIG. 10 is another flowchart indicative of master determination processing that is executed by the base station device;

FIG. 11 is a flowchart indicative of the processing that is executed by the monitor device in response to the reception of a master specification command;

FIG. 12 is a schematic diagram illustrating related-art basic communication operations that are executed between a base station device and a monitor device; and

FIG. 13 is a schematic diagram illustrating communication operations that are executed between one base station device and a plurality of monitor devices in a related-art configuration of base station device and monitor device.

### DETAILED DESCRIPTION OF THE PREFERRED EMBODIMENTS

The following describes preferred embodiments of the invention. As one of the embodiments, the following uses, by way of example, an AV (Audio Video) system that is supposed to be used indoors for example. A base station device and a monitor device configure the AV system so as to interconnect in a wireless communication manner. The base station transmits audio/video data. The monitor device is capable of receiving audio/video data supplied from the base station device and outputting the received data as image/voice signals. With this AV system, the monitor device can control the base station device. The base station device corresponds to a controlled device as the present invention and the monitor device corresponds to a controlling device as the present invention.

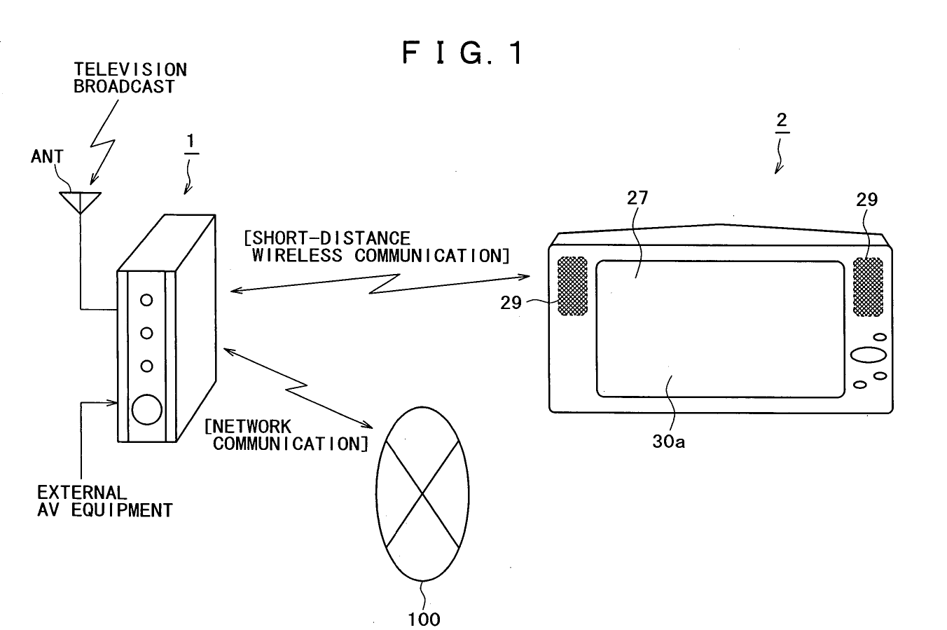

Now, referring to FIG. 1, there is shown a schematic diagram illustrating a conceptual configuration of an AV system practiced as one embodiment of the invention. It should be noted that the AV system according to one embodiment of the invention has an equipment configuration in which a plurality of monitor devices correspond to one base station device. However, for the brevity of description, the following shows only a basic configuration in which one base station device corresponds to one monitor device.

The AV system according to the present embodiment is made up of a base station device 1 and a monitor device 2 shown in FIG. 1 and is used inside a house for example. The base station device 1 and the monitor device 2 are capable of communicating each other as will be described below.

The base station device 1 is installed at a certain place inside house for example in a fixed manner. The base station device 1 has capabilities of selectively receiving television broadcasts and demodulates them to obtain audio/video information.

For this purpose, the base station device 1 can connect to an antenna ANT for television broadcast receiver in correspondence with the television broadcast receiver capabilities. Tuning and demodulation are performed on each broadcast signal received through the antenna ANT to obtain the audio/video information as a television signal. The obtained television signal is then converted into audio/video data that is compressively encoded by a predetermined algorithm.

The base station device 1 according to the present embodiment also has a video input terminal for example. The base station device 1 gets audio/video signals inputted at this video input terminal from an external AV device for example as audio/video information and converts the information into compressively encoded audio/video data in the same manner as described above.

Further, the base station device 1 has Internet (or network) connection capabilities. These capabilities allow the base station device 1 to connect with the Internet for example, thereby accessing Web sites on the Internet and transmitting/receiving electronic mail for example. Hence, the base station device 1 is installed with application software such as a Web browser and a mailer that are used for Web site browsing and electronic mail creation and transmission/reception.

The base station device 1 generates the interface images of these browser and mailer as television signals. The base station device 1 can output the generated television signals in place of the above-mentioned television broadcast video signal or combine the generated television signals with the video signal data of television broadcast. The video signal thus generated can also be converted into the video data of the compressively encoded audio/video data.

The base station device 1 can transmittably output the compressively encoded audio/video data first in a wireless manner. The base station device 1 can wirelessly transmit various pieces of content information including image information as interface images such as images of selectively received television broadcast, audio/video data inputted from AV equipment, and Internet images. Also, the base station device 1 can transmittably output various pieces of data other than the above-mentioned image information in a wireless manner. The monitor device 2, which will be described below, can receive the information thus transmitted from the base station device 1.

The base station device 1 and the monitor device 2 can transmit/receive commands with each other through this wireless communication. The transfer of commands allows the monitor device 2 to control the base station device 1 and vice versa.

It should be noted that the above-mentioned wireless communication is actually specified to a communicable range of about 30 meters in radius for example. This wireless communication is premised on a usage environment in which the base station device 1 and the monitor device 2 are relatively near with each other like in the same house for example.

The monitor device 2 has a size and a shape that are convenient for the user to carry indoors, for example.

With this monitor device 2, the signal wirelessly transmitted from the base station device 1 can be received and inputted into the inside. For example, if the inputted receive signal is the content information based on compressively encoded audio/video data, the signal is decoded into the audio/video data.

The monitor device 2 has a display block 27 based on a display device, such as LCD (Liquid Crystal Display) for example, thereby displaying the video information of the content information obtained as described above onto the display block 27 as an image. The monitor device 2 is adapted to display the audio/video information of the television broadcast selectively received by the base station device 1, the audio/video information obtained from an AV device, and the user interface image of the application software operating on the base station device 1. The arrangement of audio information outputting capabilities, such as a speaker 29, allows the monitor device 2 to output the sound of audio/video information and the sound corresponding to the operation done on a user interface image, for example.

A touch panel 30a is arranged on the display section of the display block 27. The Detection of the operation on the touch panel 30a generates operation information.

The operation information generated by user's operating the touch panel 30a is wirelessly transmitted to the base station device 1 through an antenna ANT as required. On the basis of the received information, the base station device 1 executes predetermined control processing. These operations including information transmission and reception allows the switching between the television monitor capability and the Internet capability and the selection between television channel tuning and external audio/video source, for example. In addition, these operations allow the user to perform an operation on the interface screen of such application software as a Web browser and a mailer.

As described above, the base station device 1 functions as the user interface for transmitting the content information obtainable from the outside to the monitor device. The base station device 1 obtains audio/video information from television broadcast and external AV equipment, receives various pieces of information including Web content through the Internet, and transmittably outputs the obtained content information.

The monitor device 2 also has user interface capabilities of presenting the audio/video information obtained by the base station device 1 as described above to the user through image and sound and receiving the operation inputs done by the user into this system.

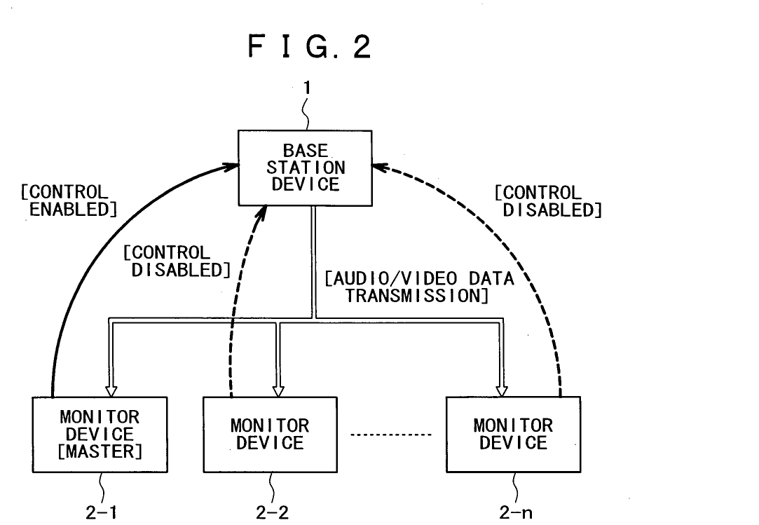

On the basis of the basic configuration of the above-mentioned pair of the base station device 1 and the monitor device 2, the present invention is embodied into an AV system as shown in FIG. 2 for example.

The AV system shown in FIG. 2 has one base station device 1 and a plurality of monitor devices 2-1 through 2-n. A plurality of monitor devices 2 are connected to one base station device 1. It should be noted that the concept of the present invention is not limited to any particular number of monitor devices 2 in the AV system.

As shown in FIG. 2, the base station device 1 wirelessly transmits the audio/video data of the content obtained as described with reference to FIG. 1 for example to the plurality of monitor devices 2-1 through 2-n at the same time. For this purpose, the base station device 1 is put in a multicast mode by a communication protocol for transmitting audio/video data.

Control of the base station device 1 by the monitor device 2 is enabled only by the monitor device that is master of the plurality of monitor devices 2-1 through 2-n. A monitor device set to master denotes that this monitor is given the right of controlling the base station device 1. In the present embodiment, only one monitor device can be set to master. Referring to FIG. 2, of the monitor devices 2-1 through 2-n, only the monitor device 2-1 is set to master (that is, only the monitor device 2-1 has the right of control).

Consequently, in FIG. 2, of the monitor devices 2-1 through 2-n, only the monitor device 2-1 can control the base station device 1. The other monitor devices (or slave devices) 2-2 through 2-n are disabled to control the base station device 1.

Thus, in the present embodiment, a control mode for controlling the base station device 1 by the monitor device 2 is used in which only a part of a plurality of monitor devices 2 is allowed to control the base station device 1. In the present embodiment, the number of monitor devices that can control the base station device is limited to one. This novel configuration consequently overcomes the trouble involved in related-art configurations in which all of a plurality of monitor devices 2 are allowed to control the base station device 1.

The following describes one specific example of the novel configuration in which a plurality of monitor devices 2 of an AV system composed of these monitor devices and one base station device 1 are demonstrated at the store.

In this example in the present embodiment, the monitor device 2-1 for example, which is master, is not on exhibit at the store; it is arranged at a place that can be accessed only by sales staff. Alternatively, the monitor device 2-1 is owned and managed by the sales staff who makes demonstration. The other monitor devices 2-2 through 2-n are arranged at the store such that customers can use them for review.

In this state, sales staff operates the master monitor device 2-1 to select an audio/video source to be outputted as a demonstration, for example. This operation includes the selection of a certain channel of television broadcast, for example.

Since the monitor device 2-1 is master and has the right of control, a command corresponding to the operation of audio/video source selection done by the sale staff is transmitted from the monitor device 2-1. In response to this command, the base station device 1 selectively obtains the audio/video data specified by the command. Then, as described above, this audio/video data is transmitted to all of the monitor devices 2-2 through 2-n in the multicast manner for example. Consequently, the audio/video source selected by the operation of the monitor device 2-1 is outputted not only to the monitor device 2-1, but also to the other monitor devices 2-2 through 2-n as audio/video data. The same audio/video data is displayed on all of the monitor devices 2-2 through 2-n on exhibit at the store.

In this state, the customer using any one of the monitor device 2-2 through 2-n on exhibit at the store performs an operation associated with control of the base station device 1. Any of these monitor devices 2-2 through 2-n are not set to master and therefore not given the right of control. Therefore, no command is transmitted from the monitor device 2-2, thereby not causing the base station device 1 to operate in accordance with the customer's operation. To be more specific, if an operation is performed on any of the monitor devices 2-2 through 2-n to switch television broadcast channels, the base station device 1 will not responds to this operation. Consequently, the audio/video data currently outputted on the monitor devices 2-1 through 2-n will not be switched to that of another channel unexpectedly.

In related-art configurations, for example, all of the monitor devices 2 can control the base station device 1. If an operation for channel selection is performed on any one of the monitor devices on exhibit at the store, the base station device 1 accordingly executes channel switching. As a result, the monitor device 2 switches the currently outputted audio/video data to that of a new channel. This is not desirable for other customers who are using a plurality of different monitor devices on exhibit. For example, the other customers who are not operating the monitor 2 confront the unexpected switching to another channel by another customer.

On the contrary, in the present embodiment, the master monitor device 2-1 for example is kept in the state where only the sales staff is allowed to operate. The other monitor devices 2-2 through 2-n are left to the use by customers. This configuration prevents the base station device 1 from operating in response to the operation done by these customers. Consequently, the novel configuration can solve the trouble that the monitor devices 2-2 through 2-n will operate unexpectedly.

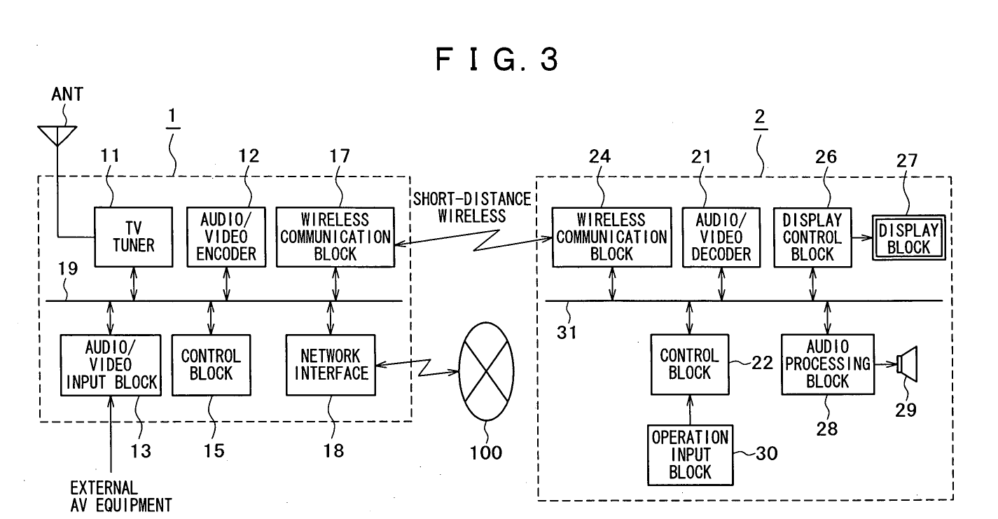

The following describes an exemplary technical configuration for realizing the operation of the AV system according to the present embodiment described with reference to FIG. 2. First, with reference to FIG. 3, exemplary internal configurations of the base station device 1 and the monitor device 2 will be described.

The base station device 1 shown in FIG. 3 has a television (TV) tuner 11 having capabilities of receiving, tuning, and demodulating predetermined television broadcasts. The TV tuner 11 captures broadcast wave received from the antenna ANT and executes tuning and demodulating the captured broadcast wave to obtain the audio/video signal of a specified channel under the control of a control block 15 for example. Then, the TV tuner 11 transmits the obtained audio/video signal to an audio/video encoder 12 through an internal data bus 19.

An audio/video input block 13 captures the audio/video signal outputted from an external AV device as audio/video data. Actually, for example, the audio/video input block 13 has a predetermined number of pairs of input terminals corresponding to predetermined signaling schemes for inputting the audio/video signal outputted from an AV device. Further, the input block 13 has a selector for selecting an audio/video signal specified by the control block 15 for example from among the audio/video signals inputted from these input terminals. If the input audio/video signal is an analog signal, the audio/video input block 13 has an A/D converter for converting this analog signal into a digital signal. The audio/video data outputted from the audio/video input block 13 is also transmitted to the audio/video encoder 12 via the internal data bus 19 under the control of the control block 15.

As described above, the data of the user interface images of a Web browser and a mailer can also be transmitted to the audio/video encoder 12.

The audio/video encoder 12 captures the audio/video data received through the internal data bus 19 and encodes the captured data into the audio/video data compressed by a predetermined data compression algorithm. There is no restriction to any particular data compression algorithm. Therefore, any one of the algorithms falling within the MPEG (Moving Picture Experts Group) standard may be employed in the current situation.

The compressed audio/video data outputted from the audio/video encoder 12 is transmitted to wireless communication block 17 or a network interface 18 to be described later, under the control of the control block 15.

The wireless communication block 17 executes communication processing in accordance with a predetermined communication protocol that is used for the electromagnetic wave wireless communication as the present embodiment. For the communication protocol of the electromagnetic wave wireless communication of the present embodiment, TCP/IP is used, but not exclusively. Especially, for the communication of content data, such as audio/video data, UDP (User Datagram Protocol) of TCP/IP is used in this case. The communication protocol common to the Internet is used although the present embodiment is based on electromagnetic wave wireless communication. Because TCP/IP has already been widespread in the Internet, its use is advantageous in ease of application.

For example, at transmission, the content data is packetized so as to enable the transmission/reception based on TCP/IP, thereby transmittably outputting the packetized data after performing predetermined carrier modulation for example in a wireless manner. At reception, the information transmitted in a wireless manner is received and the received information is demodulated on a packet basis. Then, the demodulated information is unpacketized in accordance with the communication protocol of TCP/IP, thereby obtaining real data, such as commands and content information.

The communication through the Internet (network) 100 is executed by the network interface 18. As known, the communication protocol by the Internet is also TCP/IP, so that the network interface 18 executes the processing such that the communication is executed through the Internet in accordance with TCP/IP.

Also in this case, at transmission, processing, such as packetizing, is executed so as to enable the transmission/reception in accordance with TCP/IP and the packetized data is transmitted from the sender source to destination terminals on the Internet 100. At reception, the information transmitted from the sender source through the Internet 100 is demodulated in a predetermined manner by unpacketizing for example, thereby obtaining the real data of commands and content information.

The actual network interface 18 may have a configuration that corresponds to LAN, such as Ethernet. Use of this configuration allows the use of a so-called broadband communication line represented by xDSL (Digital Subscriber Line), FTTH (Fiber To The Home), or CATV (Cable Television). The configuration based on the modem allows the Internet connection by the telephone line.

As described above, the audio/video data compressively encoded by the audio/video encoder 12 is transmittably outputted to the monitor device 2. In transmitting this compressed audio/video data to the monitor device 2 by short-distance wireless communication, the control block 15 executes a control operation such as this compressed audio/video data is inputted in the wireless communication block 17 via the internal data bus 19. The wireless communication block 17 executes packetizing and carrier modulation on the inputted compressed audio/video data as described above and transmits the packetized and modulated data as radio wave.

As seen from the description made so far, the control block 15 executes various control processing operations in the base station device 1. The control block 15 is configured by a microcomputer having a CPU (Central Processing Unit), a ROM, and a RAM for example. In a known manner, the CPU executes processing in accordance with programs and various kinds of setting information stored in the ROM. The RAM provides an area in which each program to be executed by the CPU is expanded. The RAM also provides a computation work area in which the CPU executes processing.

A configuration is also possible in which a hard disk drive (HDD) is attached to the base station device 1 to store content data including audio/video data. In such configuration, the content data stored in the HDD can also be transmittably outputted to the monitor device 2 by wireless communication or the Internet.

The monitor device 2 shown in FIG. 3 also has a wireless communication block 24 for executing electromagnetic wave wireless communication with the base station device 1. The wireless communication block 24 may be configured in the same manner as the wireless communication block 17 of the base station device 1, for example.

When compressed audio/video data is transmittably outputted from the wireless communication block 17 of the base station device 1 as content information as described above, the wireless communication block 24 of the monitor device 2 extracts the transmitted compressed audio/video data by receiver demodulation processing.

An audio/video decoder 21 captures the compressed audio/video data transmitted as described above and decodes the received data in accordance with its format, thereby obtaining decompressed video signal data and audio signal data. Under the control of a control block 22, the obtained video signal data is transmitted to a display control block 26 and the obtained audio signal data is transmitted to an audio processing block 28.

When the video signal data has come from the audio/video decoder 21, the display control block 26 executes signal processing such that this video signal data will be displayed on the display block 27 and drives the display block 27. If a GUI image is displayed for a touch panel operation for example, the display control block 26 generates image data as a GUI image in accordance with an instruction by the control block 22 and executes control processing such that the generated image data is displayed on the display block 27 as an image. The display control block 26 also executes image signal processing for superimposing the GUI image portion onto a predetermined position of the main image that is the video signal data received from the audio/video decoder 21.

The display block 27 is configured by a display device, such as LCD (Liquid Crystal Display), and arranged such that its display screen section is exposed on mostly the entire front surface of the monitor device as shown in FIG. 1. When the above-mentioned operation is executed by the display control block 26, the image of the audio/video data transmitted from the base station device 1 and the GUI image are displayed on the display screen of the display block 27.

The audio processing block 28 captures the audio signal data received from the audio/video decoder 21 and executes predetermined digital audio signal processing, D/A conversion, and amplification for example, eventually outputting the processed data to a speaker 29, from which it is sounded.

In the audio/video decoder, compressed audio/video data is decoded. The compressed audio/video data here includes the data in which only the video signal data is compressively encoded or only the audio signal data is compressively encoded, in addition to MPEG-based video signal data and audio signal data in which the video signal data and the audio signal data are compressively encoded such that they are synchronized with each other in reproduction time axis. Moreover, the audio/video decoder 21 can also cope with the decoding of the image data having a predetermined format as a still image.

It should be noted that, as described above, the audio/video data that is compressively encoded so as to synchronize the audio/video data in reproduction time axis is required in the present embodiment to be transmitted as streaming data and reproduced with temporal continuity. If the monitor device 2 receives this audio/video data, the audio/video decoder 21 executes decoding such that the video output and the audio output are reproduced as synchronized with each other in reproduction time axis. In addition, for the video signal data and the audio signal data that are decoded as described above to be reproduced without interruption, the control block 22 controls the decoding timing in the audio/video decoder 21 and the timing of transmitting the decoded data to the display control block 26 or the audio processing block 28.

It would be understood from the above-mentioned description that the television broadcast received and demodulated in the base station device 1 and the audio/video information inputted by the audio/video input block 13 from an external AV device are outputted to the monitor device 2 as audio/video data for viewing.

An operation input block 30 shown in the monitor device 2 of FIG. 3 has, as the user interface associated with operation input, all of controls, operation input block and its controls, and a device for generating operation commands in accordance with operations done on the operation input block to output these commands to the control block 22. Therefore, the operation input block 30 may also include a touch panel 30a arranged on the display block 27.

Although not especially shown, the operation input block 30 may also include a remote controller arranged as an entity separate from the monitor device 2, thereby receiving command signals transmitted from this remote controller to generate the above-mentioned operation commands.

The control block 22 controls the other components in the monitor device 2 such that an operation corresponding to an operation command received from the operation input block 30 is obtained. For example, if an operation that is conclusive on the monitor device 2 is executed for controlling the brightness of the LCD-based display block 27, the control block 22 controls the display control block 26 to adjust the light quantity of the back light of the LCD, for example.

Also, depending on an operation done on the operation input block 30 of the monitor device 2, for example, the monitor device 2 may also control various operations of the base station device 1. As an example, an operation for switching channels tuned in by the TV tuner 11 of the base station device 1 is executed as an operation on the operation input block 30. The control block 22 inputting an operation command corresponding to this operation instructs the wireless communication block 24 to transmit a channel switching request command. In response, the control block 22 instructs the wireless communication block 24 to transmit a channel switching request command.

The above-mentioned control operation by the control block 22 causes the wireless communication block 24 or a network interface 25 to transmit a channel switching request command to the base station device 1. The base station device 1 demodulates the received command through the wireless communication block 17 or the network interface 18 and transmits the demodulated command to the control block 15. The control block 15 controls the TV tuner 11 so as to switch channels as directed by this command. Consequently, the audio/video output of the monitor device 2 is switched from the audio/video data displayed so far to the audio/video data of the channel specified by the user.

However, in the present embodiment, the above-mentioned command transmission for controlling the base station device 1 by the monitor device 2 can be effected only by the monitor device 2 that has the right of control as described with reference to FIG. 2.

The control block 22 executes various control processing operations in the monitor device 2. This control block 22 is also configured by a microcomputer having a CPU, a ROM, and a RAM, for example.

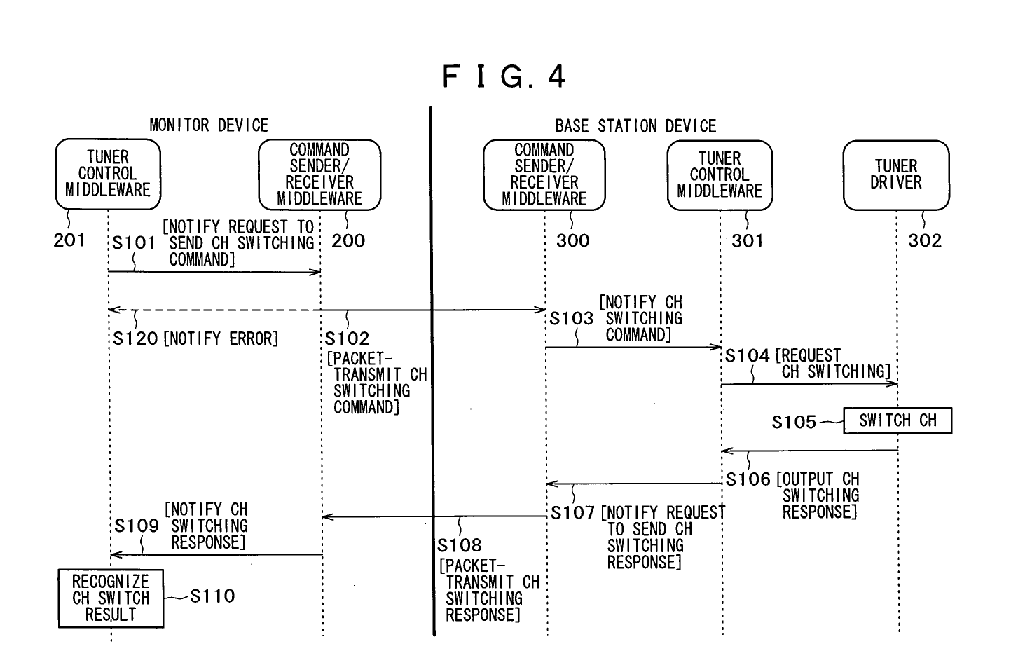

The following describes, with reference to FIG. 4, an exemplary procedure of the communication processing operations for controlling the base station device 1 by the monitor device 2 in the present embodiment. In the following description, controlling of the switching between television broadcast receiver channels by the base station device 1 will be used for example.

In controlling the switching between television broadcast receiver channels, a program module shown in FIG. 4 operates.

First, on the side of the monitor device 2, a tuner control middleware 201 and a command sender/receiver middleware 200 execute processing. The tuner control middleware 201 and the command sender/receiver middleware 200 are middleware programs that are executed by the control block 22 (CPU) of the monitor device 2 and are stored in the ROM of the control block 22 for example. The tuner control middleware 201 executes the processing corresponding to a command issued in response to a user operation on the monitor device 2 for controlling the TV tuner 11. The command sender/receiver middleware 200, positioned immediately below the tuner control middleware 201, executes the control processing of transmitting and receiving commands with the actual base station device 1 by electromagnetic wave wireless communication. These commands are issued and received by the middleware including the above-mentioned tuner control middleware 201.

On the side of the base station device 1, a tuner driver 302, a tuner control middleware 301, and a command sender/receiver middleware 300, from upper layer to lower layer, execute processing. These middleware and driver programs are also executed by the control block 15 (CPU) in the base station device 1 and are stored in the ROM of control block 15 for example.

The tuner driver 302 controls the operation of the TV tuner 11 in accordance with a specification request from the tuner control middleware 301. The tuner control middleware 301 executes a specification request for the tuner driver 302. This specification request can be executed in response to a command sent from the command sender/receiver middleware 300. The command sender/receiver middleware 300 executes the processing of transmitting and receiving commands with the command sender/receiver middleware 200 of the monitor device 2 by electromagnetic wave wireless communication and executes the processing of command transmission/reception with the upper-layer middleware.

Now, if a user operation is performed on the monitor device 2 for switching television broadcast receiver channels, the tuner control middleware 201 of the monitor device 2 sends a request to the command sender/receiver middleware 200 for transmitting a channel (CH) switching command in step S101.

The command sender/receiver middleware 200 receives the channel switching command transmission request. If this monitor device 2 is set to master (or has the right of control), the middleware 200 packetizes the channel switching command in accordance with the communication format of electromagnetic wave wireless communication as shown in step S102 and transmits the packetized command to the base station device 1.

The packetized channel switching command transmitted from the monitor device 2 is extracted from packets to be received by the command sender/receiver middleware 300 of the base station device 1. In step S103, the command sender/receiver middleware 300 sends the received channel switching command to the tuner control middleware 301.

In step S104, the tuner control middleware 301 requests the tuner driver 302 for channel switching on the basis of the received command. In step S105, in response to this request, the tuner driver 302 executes control on the TV tuner 11 so as to tune in the channel specified by the request. When the control operation of step S105 has been completed, the tuner driver 302 outputs a response indicative of the normal execution of channel switching in step S106.

Receiving the channel switching response, the tuner control middleware 301 sends a request to the command sender/receiver middleware 300 for transmitting the channel switching response in step S107. In step S108, the command sender/receiver middleware 300 transmits the channel switching response to the command sender/receiver middleware 200 of the monitor device 2.

Receiving the channel switching response, the command sender/receiver middleware 200 sends the channel switching response to the tuner control middleware 201 in step S109. In step S110, the tuner control middleware 201 recognizes that the channel switching has normally been executed on the base station device 1 in response to the channel switching request issued by the tuner control middleware 201.

The control operations for controlling the TV tuner 11 include audio multiplex mode switching and the input switching between audio/video data output from an external AV device and audio/video data outputted from the TV tuner 11, in addition to the above-mentioned receiver channel switching. These control operations can also be realized by transmitting and receiving commands according to the contents of control by following the above-mentioned steps S101 through S110 shown in FIG. 4. Also, the control operations associated with other than the TV tuner 11, such as the operations for the Internet applications including a Web browser and a mailer for example, are executed by following the procedure shown in FIG. 4.

The procedure of transmitting and receiving commands between the monitor device 2 and the base station device 1 indicated in steps S101 through S110 in FIG. 4 is executed if the monitor device 2 is set to master. The monitor device 2 has the right of controlling the base station device 1.

If the monitor device 2 is not set to master as the procedure shown in FIG. 4, the command sender/receiver middleware 200 of the monitor device 2, if requested for the transmission of a channel switching command in step S101, will not execute the transmission of the channel switching command in step S102. Alternatively, the command sender/receiver middleware 200 notifies the tuner control middleware 201 of an error in step S120. In response, the tuner control middleware 201 recognizes the error in the channel switching in step S110. It should be noted that the processing of determining which of step S102 and step S120 is executed by the command sender/receiver middleware 200 will be described later.

If the processing procedure for executing step S120 has been reached, the channel switching command is not issued and transmitted to the base station device 1, so that the base station device 1 will not execute channel switching.

In the present embodiment, if the monitor device 2 is not master, the above-mentioned description denotes that the command sender/receiver middleware 200 does not execute command transmission regardless of the kinds of commands (control commands). If the monitor device 2 is not master, control cannot be executed on the base station device 1; in other words, only the monitor device 2 that is set to master can control the base station device 1 by following steps S101 through S110 shown in FIG. 4.

As seen from the processing procedure shown in FIG. 4, the command sender/receiver middleware 200 determines whether the command transmission to the base station device 1 is enabled or disabled depending upon whether or not the monitor device 2 is master. In the present embodiment, the program configuration of the command sender/receiver middleware 200 realizes that only the monitor device 2 set to master can control the base station device 1. This will be further described below.

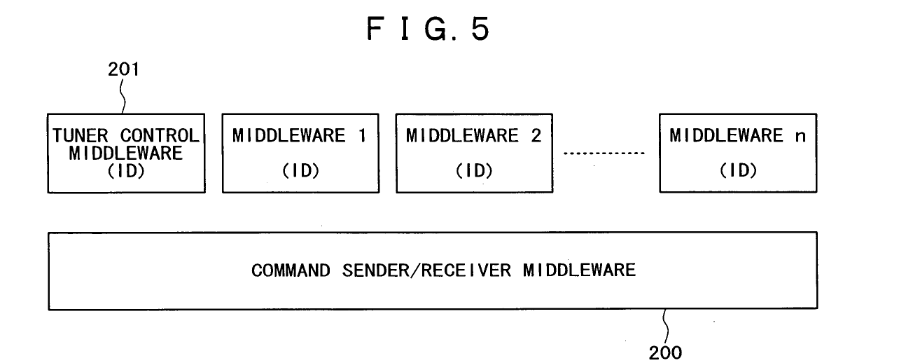

Referring to FIG. 5, there is shown a schematic diagram illustrating a middleware structure associated with command transmission/reception.

As shown in the figure, the monitor device 2 according to the present embodiment has a predetermined number of middleware programs (or applications) 1 through n on the same layer as the tuner control middleware 201 shown in FIG. 4. These middleware programs 1 through n have program configurations corresponding to the operation of a Web browser and the control of the base station device 1 as control middleware, for example.

The command sender/receiver middleware 200 exists on the lower layer, which is common to these middleware programs on the upper layer. The command sender/receiver middleware 200 executes communication with not only the tuner control middleware 201 but also other middleware programs 1 through n by following the procedure shown in FIG. 4, which allows the transmission and reception of commands with the base station device 1 (in the present embodiment, however, this command transmission/reception can be executed only when the monitor device 2 is master).

Further, in the present embodiment, each of the tuner control middleware 201 and the middleware programs 1 through n, which are on the upper layer to the command sender/receiver middleware 200, is assigned with a unique middleware group ID for its identification. The middleware group ID is also set to each of the corresponding middleware programs in the base station device 1. The middleware in the base station device 1 corresponding to the tuner control middleware 201 of the monitor device 2 is the tuner control middleware 301, for example, so that the tuner control middleware 201 and the tuner control middleware 301 are assigned with the same middleware group ID.

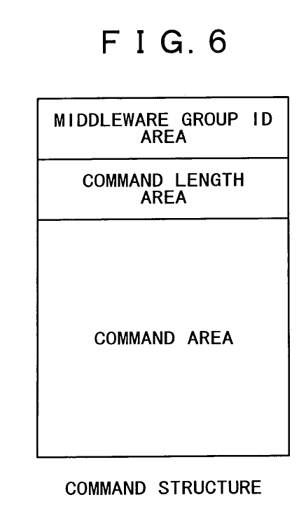

Referring to FIG. 6, there is shown an exemplary format of each command that is transmitted or received between the command sender/receiver middleware 200 of the monitor device 2 and the command sender/receiver middleware 300 of the base station device 1.

For example, as shown in the figure, the command structure is made up of a middleware group ID area, a command length area, and a command area.

The middleware group ID area stores the value of the middleware group ID of the middleware that sent a command transmission request to the command sender/receiver middleware 200. In the case of FIG. 4, this middleware group ID area stores the middleware group ID of the tuner control middleware 201.

When the command sender/receiver middleware 300 receives a command transmitted in the procedure equivalent to step S102 on the side of the base station device 1 for example, this middleware group ID is referenced to send the received command to the upper middleware having the same middleware group ID on the side of the base station device 1 in the procedure equivalent to step S103. Likewise, when a response is transmitted from the base station device 1 in the procedure equivalent to step S108 shown in FIG. 4, the transmission is executed by the command format shown in FIG. 6. The same middleware group ID as stored in the command at the time the transmission was made from the monitor device 2 to the base station device 1 is stored into the middleware group ID area. Consequently, also when the command sender/receiver middleware 200 of the monitor device 2 receives a response, the middleware group ID stored in the middleware group ID area of this response is referenced to send the response to the upper middleware set with this middleware ID.

In the present embodiment, a middleware group ID is set to the middleware that is upper to the command sender/receiver middleware 200 and the command sender/receiver middleware 300 with respect to the command sender/receiver processing. On the basis of this middleware group ID, the command sender/receiver middleware 200 and the command sender/receiver middleware 300 recognizes the middleware group ID to be notified by the transfer of command and response.

This novel configuration allows the normal transmission of commands by the command sender/receiver middleware 200 and the command sender/receiver middleware 300 if control middleware for example is added to the AV system composed of the base station device 1 and the monitor device 2 so as to make the AV system multifunctional for example. The middleware group ID is set to this control middleware. In other words, the above-mentioned novel configuration makes it unnecessary to change the program configuration for example for the command transmission/reception for making the system multifunctional, thereby providing high expandability for the functions that are realized by software, for example.

The command length area shown in FIG. 6 stores a value indicative of the data length of a command area that follows.

The command area stores the substance of command. The identification information for identifying whether it is a command or a response and the information indicative of the contents required as a command or a response.

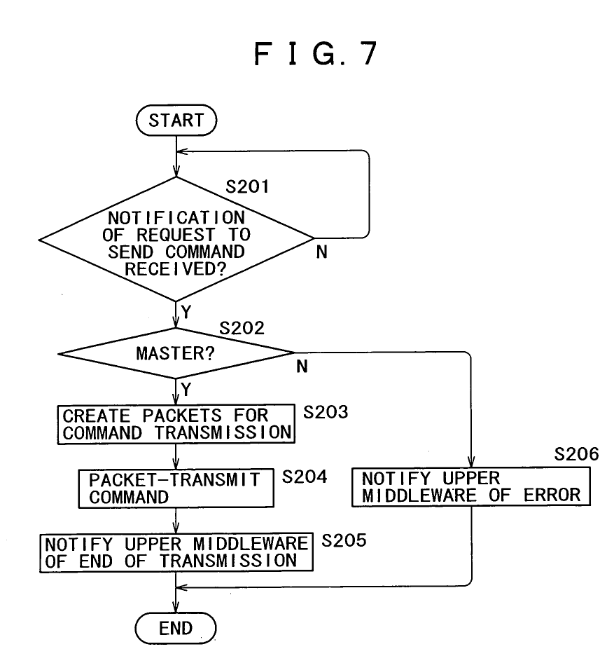

The flowchart shown in FIG. 7 is indicative of the processing for command transmission in the monitor device 2. The processing shown in the figure is executed by the command sender/receiver middleware 200.

First, in step S201, the command sender/receiver middleware 200 is waiting for a request for command transmission to come from the upper middleware. When the command sender/receiver middleware 200 receives a command transmission request from the upper middleware as shown in step S101 in FIG. 4, for example, the procedure goes from step S201 to step S202.

In step S202, it is determined whether the monitor device 2 concerned is set to master, that is to say, has the right of control of the base station device 1. The information whether the monitor device 2 having the command sender/receiver middleware 200 is set to master is managed by the command sender/receiver middleware 200. The processing to be executed when this setting is executed will be described later. When an instruction for making the monitor device 2 be master comes, the command sender/receiver middleware 200 writes, as setting information, the data indicative of that the monitor device 2 has been set to master to a rewritable non-volatile memory area in the control block 22 for example. If the monitor device 2 is not set to master, the command sender/receiver middleware 200 writes, as the above-mentioned setting information, the data indicative that the monitor device 2 has not been set to master.

In step S202, the above-mentioned setting information is referenced to determine whether or not the monitor device 2 is set to master. If the monitor device 2 is found set to master, then the decision is YES and the procedure goes to step S203.

In step S203, control processing is executed for generating packets for transmitting the command notified in step S201. In step S204, control processing is executed to transmittably output the packetized command to the command sender/receiver middleware 300 of the base station device 1 by electromagnetic wave wireless communication. The processing in steps S203 and S204 is equivalent to the processing of step S102 shown in FIG. 4. Therefore, when command transmission is executed in these steps S203 and S204, it can be understood that an operation in accordance with this command is executed in the base station device 1. If the monitor device 2 is set to master, the command transmission for controlling the base station device 1 is enabled.

Although not shown in FIG. 4, if the command transmission has been ended by the processing of step S204 for example, then, in step S205, the upper middleware that requested the command transmission in step S201 is notified of the normal end of the command transmission.

On the other hand, if, in step S202, the decision is NO, indicating that the setting information tells that the monitor device 2 is not set to master, then the procedure goes to step S206. In step S206, the upper middleware that requested the command transmission in step S201 is notified of an error. The processing of the error notification in step S206 is equivalent to the processing of step S120.

Thus, if the monitor device 2 is not set to master, the procedure goes from step S202 to step S206, thereby preventing the command transmission from being executed to the base station device 1. Consequently, any monitor device 2 that is not master cannot control the base station device 1.

As seen from the processing shown in FIG. 7, the command sender/receiver middleware 200 of the monitor device 2 determines whether the monitor device 2 is set to master and, on the basis of this decision, determines whether to enable the command transmission to the base station device 1.

For example, this decision whether or not to enable the command transmission may be executed by each upper middleware of the command sender/receiver middleware 200, such as the tuner control middleware 201. Each of the upper middleware may determine whether the monitor device 2 is master and then determine whether or not to enable the notification of command transmission request. In this case, however, an algorithm must be given for determining whether or not to enable the notification of command transmission request on the basis of whether or not the monitor device 2 is master, for each of a plurality of upper middleware applications. This inevitably complicates the program design, which in turn may impair the advantage of the present embodiment of facilitating the functional expansion by additionally installing the upper middleware.

On the contrary, the above-mentioned configuration of the present embodiment in which the command sender/receiver middleware 200 below and common to the upper middleware determines whether or not to enable command transmission need not change the execution of operations made so far, regardless of whether or not the monitor device 2 is master. The upper middleware need not be changed in design. Further, when the upper middleware is added, since no different operation takes place depending on whether or not the monitor device 2 is master, thereby making simple the program design for example by that much, which in turn can maintain the high expandability.

It should be noted that the above-mentioned upper middleware is located below a variety of application programs for example and these application programs also need not be especially changed in accordance with the system operation of the present embodiment.

In the base station device 1, the command sender/receiver middleware 300 need not be especially added or changed with respect to the processing associated with the decision whether or not the monitor device 2 has been set to master. In the present embodiment, the command sender/receiver middleware 200 of the monitor device 2 determines whether or not to execute command transmission on the basis of the decision whether or not the monitor device 2 is master. Hence, the base station device 1 may only execute the processing of responding to a command when the command is sent, thereby eventually providing a system operation that only the monitor device 2 that is master can control the base station device 1. It should be noted again that, since the command sender/receiver middleware 200 need not be changed, the middleware and drivers upper thereto may only be configured so as to execute the same operation as before and therefore need not be especially changed in design.

In the present embodiment, in order to provide a system operation that, of a plurality of monitor devices, only the monitor device 2 that is master can control the base station device 1, the algorithm may only be changed for the command sender/receiver middleware 200 of the monitor device 2 in accordance with the decision whether or not the monitor device 2 is set to master. This configuration does not involve a major program change in providing the above-mentioned system operation, so that the realization of the configuration is significantly easy and the efficiencies of design and development can be enhanced.

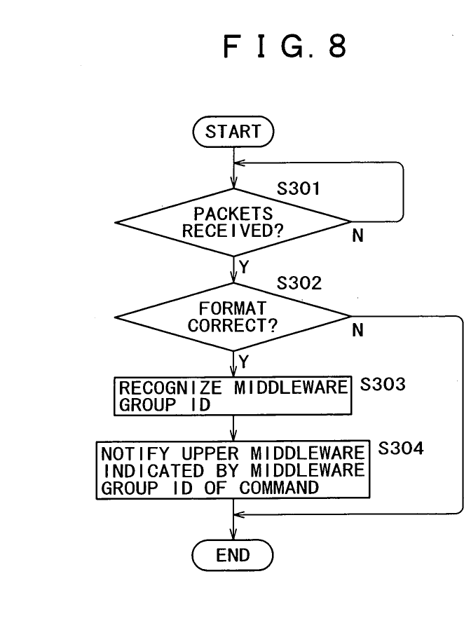

The flowchart shown in FIG. 8 is indicative of the execution by the command sender/receiver middleware 300 to respond the command reception on the side of the base station device 1.

First, in step S301, the command sender/receiver middleware 300 waits for the reception of packets by the communication network as electromagnetic wave wireless transmission. Having recognized the packet reception, the procedure goes to step S302.

When the packet reception is made in step S301, a command having the structure as shown in FIG. 6 for example is extracted from the received packets. In step S302, the structure and contents of the extracted command are checked to determine whether or not the format of the received command is normal.

If the format is found not normal in step S302, then the processing for the received command will not be executed, for example.

On the other hand, if the format is found normal in step S302, the processing for the received command shown in steps S303 and S304 is executed.

First, in step S303, the middleware group ID area of the command obtained by extracting from the received packets is referenced to recognize the middleware group ID stored in this area. In step S304, the contents of the received command are sent to the upper middleware indicated by the recognized middleware group ID. The processing of steps S303 and S304 is equivalent to the procedure of step S103 shown in FIG. 4.

As seen from FIG. 8, the command sender/receiver middleware 300 of the base station device 1 does not especially determine whether or not command acceptance is enabled depending on whether or not the monitor device 2 is master. In the present embodiment, the realization of the system operation as the present embodiment does not especially require to change the command sender/receiver middleware 300 of the base station device 1 as described above. It is also unnecessary, in the realization of the system operation, to especially change the programs of the middleware, drivers, and applications that are upper to the command sender/receiver middleware 300. None of the programs on the side of the base station device 1 need be changed.

It should be noted that a program for executing the processing of determining the master of the monitor devices 2 is installed in the base station device 1, thereby defining a command (a master specification command) for specifying one of the monitor devices 2 to become master, which will be described below. Also, it is unnecessary for this program installation to be done for each of the control middleware programs.

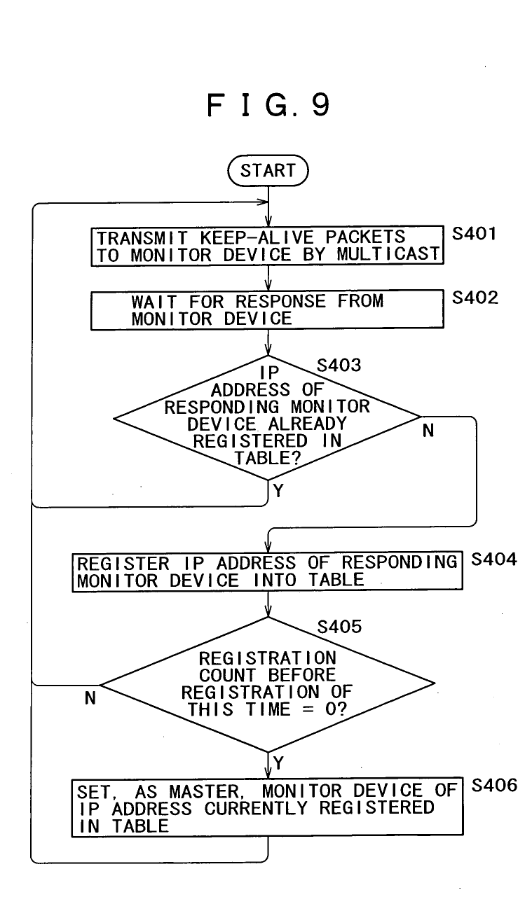

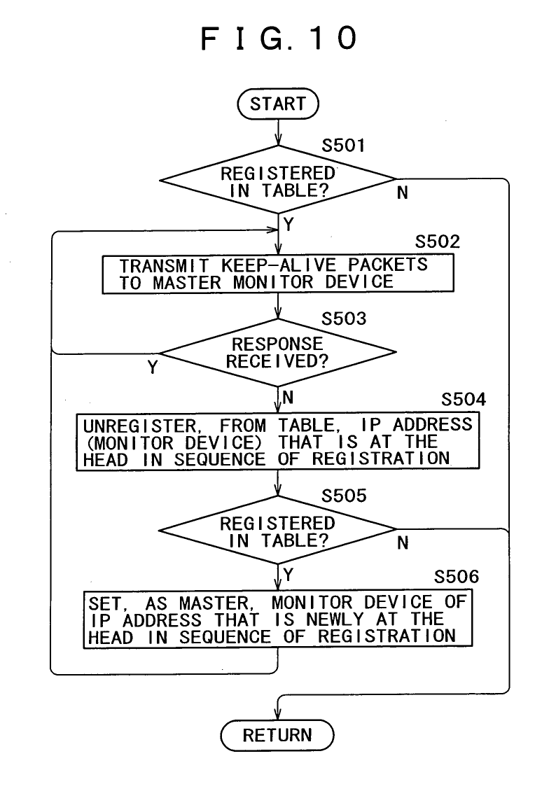

The flowcharts shown in FIGS. 9 and 10 are indicative of the processing for determining the monitor device 2 that is to be master by the base station device 1.

The processing shown in these figures is executed by the control block 15 (CPU) in accordance with the master determining program stored in the internal ROM for example. It is assumed that the plurality of monitor devices 2 configuring the AV system corresponding to the base station device 1 belong to a preset particular multicast group. In order to manage each monitor device 2 for which the communication based electromagnetic wireless communication network is established, the base station device 1 holds a table (a connection status table) that stores IP addresses (alternatively MAC (Media Access Control) addresses) of the monitor devices 2 for which the communication is established. This connection status table is created after starting up of the base station device 1, for example, and is stored in the RAM of the control block 15 to be updated in accordance with the subsequent monitor device 2 connection status.

First, in step S401 shown in FIG. 9, the base station device 1 transmits keep-alive packets to all of the monitor devices 2 belonging to the multicast group corresponding to this AV system at constant time intervals in the multicast mode.

In step S402, the base station device 1 waits for the reception of a response from the monitor device 2 to the transmission of these keep-alive packets. For this wait time, a time it takes for the monitor device 2 that received keep-alive packets to be able to normally return the response is set, for example.

In step S403, the base station device 1 recognizes the IP address of the monitor device that has returned the response in step S402, determining whether the recognized IP address has already been registered in the connection status table.

If the IP address is found registered in the connection status table in step S403, then the procedure returns to step S401. The transmission of keep-alive packets at certain time intervals is repeated as it is.

On the other hand, if, with any monitor device among the monitor devices 2 that returned the response in step S402, the IP address is found not registered in the connection status table, then the decision in step S403 is NO, upon which the procedure goes to step S404.

In step S404, the IP address of the monitor device of which IP address is not registered in the connection status table is added to the table. It should be noted that, if the IP addresses of two or more monitor devices are registered, the registration is sequentially made in the order of returning responses, for example.

Next, in step S405, it is determined whether the number of IP address registrations before the current registration is 0 with respect to the connection status table registration status obtained in step S404. If the decision of step S405 is NO, indicating that the already registered IP address has been found, then the procedure returns to step S401.

On the other hand, if the decision is YES, indicating that the number of IP address registrations has been found to be 0 in step S405, then the processing of step S406 is executed.

Going from step S405, in which the decision is YES, to step S406 denotes that a status transition takes place from a status in which there is no monitor device 2 connected to the base station device 1 to a status in which there appears a monitor device 2 connected to the base station device 1 for the first time. Therefore, in this case, the monitor device 2 having the IP address first registered among the IP addresses in the connection status table is selected as master in step S406. For this, a master specification command is transmitted to the monitor device determined to be master. The processing to be executed in response to the master specification command will be described later; consequently, however, the monitor device 2 that has received the master specification command sets itself to master.

Also, the base station device 1 executes master determination processing shown in FIG. 10.

Referring to FIG. 10, first, in step S501, it is determined whether there is any one of registration in the connection status table. If no registration is found and therefore the decision is NO, then the processing shown in FIG. 10 ends. On the other hand, if there is found any one registration in the connection status table and therefore the decision is YES, then the processing of step S502 and on is executed.

If there is any one registration in the connection status table, it denotes that the master monitor device 2 is set without question as seen from FIG. 9. Therefore, the processing of step S502 and on shown in FIG. 10 will be executed in parallel to the processing shown in FIG. 9 after the master monitor device 2 is set by the processing of step S406 shown in FIG. 9.

In step S502 shown in FIG. 10, keep-alive packets are transmitted to the monitor device currently set to (or determined as) master. In step S503, it is determined whether or not a response has been received.

If a response has been received from the master monitor device 2 in step S503, then the procedure returns to step S502. On the other hand, if a response from the master monitor device 2 has not been received within a certain period of time for example, then the decision in step S503 is NO and the procedure goes to step S504.

Going from step S503, in which the decision is NO, to step S504 denotes that the communication between the monitor device 2 that has been master so far and the base station device 1 has been disconnected. The disconnection may be such that the monitor device 2 has been moved outside the range of electromagnetic wave wireless communication, the power has been cut, or some malfunction has taken place, for example.

Therefore, in step S504, because of the failure of the communication with this master monitor device, the processing is executed to unregister this monitor device from the connection status table.

It is assumed here that the IP addresses (or the monitor devices) registered in the connection status table be managed in the order of their registration timing. As described above with reference the processing of step S406, the master monitor device has the IP address that was registered first in the connection status table among the other IP addresses. The master is determined by selecting the monitor device that has been registered first among those registered in the connection status table.

Therefore, in step S504, the IP address (or the monitor device) that is at the first in the order of registration in the connection status table at this point of time is deleted from the connection status table. Consequently, the monitor device 2 that has been set to as the master is deleted from the connection status table.

In step S505, it is determined whether any IP address is registered in the current connection status table as a result of the unregistration processing of step S504. If the decision is NO, it indicates that there is currently no monitor device 2 for which the connection is established, so that the processing shown in the figure comes to an end. It should be noted that, if the processing shown in the figure comes to an end, the processing previously described with reference to FIG. 9 is continued, so that, when a monitor device for which the connection has been established appears subsequently, its IP address is registered in the connection status table.

On the other hand, if one or more IP addresses are found in the current connection status table in step S505 and therefore the decision is YES, then the procedure goes to step S506.

If any IP addresses are left in the connection status table after the deletion of registration done in step S504, the IP address (or the monitor device) that was second in the order of registration before the deletion is put to the top of the connection status table. The following IP addresses, if any, are moved forward sequentially.

In step S506, the monitor device having the IP address newly put to the top of the connection status table is selected as master in accordance with the above-mentioned master determination rule. In order to execute this selection processing, a master specification command is transmitted to the monitor device 2 selected as master, in the same manner as described with reference to step S406.

It should be noted that the master determination processing shown in FIGS. 9 and 10 is illustrative only. For example, if, from among the monitor devices that have responded to an enquiry such as keep-alive packet, only one of them can be selected as master, then the master determination rule and the contents of the processing compliant with this rule may be changed appropriately.

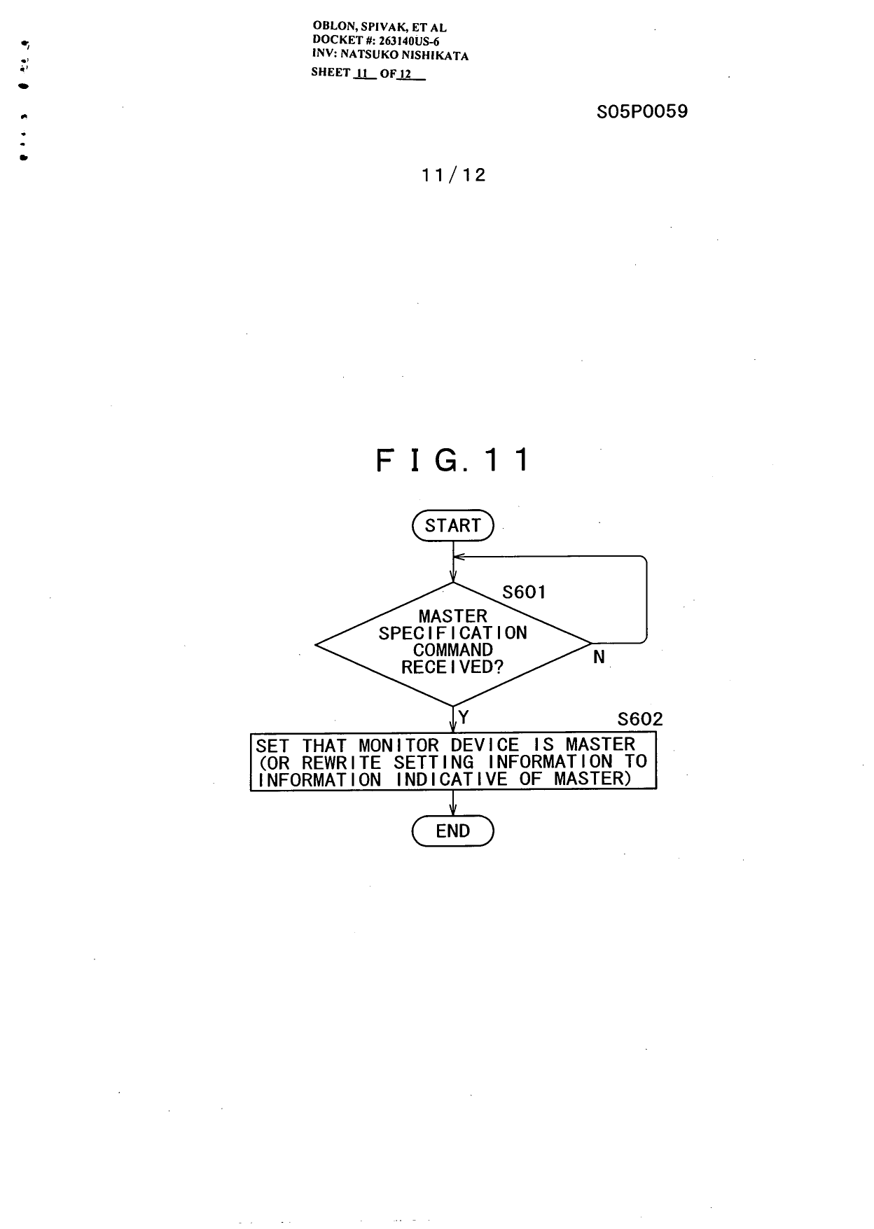

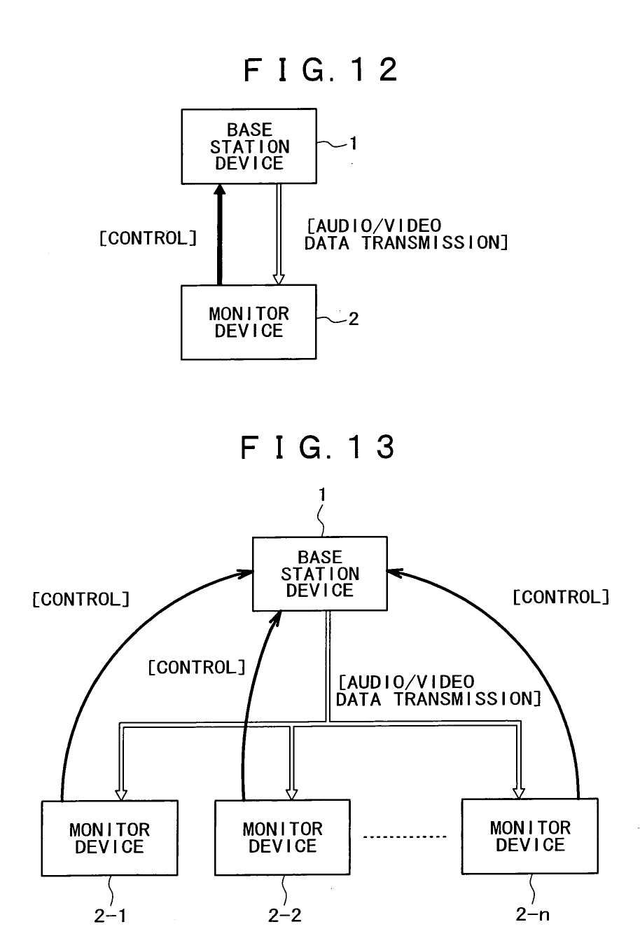

The flowchart shown in FIG. 11 is indicative of the processing to be executed by the monitor device 2 in response to the transmission of a master specification command executed in step S406 in FIG. 9 or step S506 in FIG. 10. This processing is also executed by the control block 15 (CPU) by executing a program stored in the internal ROM for example.

In this case, the monitor device 2 waits for the reception of a master specification command in step S601. When the master specification command has been received, then the processing of step S602 is executed.

For example, the monitor device 2 stores the information indicative that the monitor device 2 is not initially set to master as the setting information stored for the decision in step S202 described above with reference to FIG. 7.

In step S602, the setting information is rewritten to that the monitor device 2 is set to master, so that the monitor device 2 is set to master.

It should be noted that, for the above-mentioned embodiment, an AV system based on a base station device and one or more monitor devices is used for example; it will be apparent that the present invention is also applicable to control systems other than mentioned above. For example, the base station device and the monitor devices may be personal computers. Especially, monitor devices may be small-size terminal devices, such as PDAs (Personal Digital Assistants) that is higher in portability or mobility.

While preferred embodiments of the present invention have been described using specific terms, such description is for illustrative purpose only, and it is to be understood that changes and variations may be made without departing from the spirit or scope of the following claims.

1. A control system having one controlled device and a plurality of controlling devices, comprising:
communication means for establishing a communications link between said controlled device and one of said plurality of controlling devices;
control command means for executing control over said controlled device by a predetermined command dispatched from one of said plurality of controlling devices to said controlled device via said communication link;
request means for requesting said control command means to dispatch the predetermined command to said controlled device;
setting means for setting a control right to a particular one of said plurality of controlling devices; and
controller means for, if said particular one of said plurality of controlling devices is set to have the control right, executing said predetermined command in response to the request by said request means and, if said particular one of said plurality of controlling devices is not set to have the control right, not executing the predetermined command in response to the request by said request means.

2. The control system according to claim 1, wherein said setting means comprises:
a computer readable medium containing a list of candidate controlling devices, said list including identifications of a set of the plurality of controlling devices that responded in order to a communication acknowledge signal from the controlled device; and
means for selecting, as said particular controlling device, a highest priority device of said plurality of controlling devices that is written as a highest order entry in the list, but if said highest priority device is not communicating with said controlled device, said highest priority device is deleted from the list, and a next highest priority device is selected from the list as said particular controlling device.

3. The control system of claim 1, wherein said communication means establishes a wireless communications link.

4. The control system of claim 2, wherein said identifications include Internet protocol (IP) addresses.

5. The control system of claim 1, wherein said predetermined command is a channel switching command.

6. A controlling device comprising:
a communication interface configured to exchange signals via a communications link with a controlled device;
a control command mechanism configured to execute control over said controlled device by a predetermined command dispatched via said communication interface;
a request mechanism configured to request said control command mechanism to dispatch the predetermined command to said controlled device;
a setting mechanism configured to selectably set a control right to form a controlling/controlled device pair with said controlled device; and
a controller configured to, if the control right is set by said setting mechanism, execute said predetermined command in response to the request by said request mechanism and, if the control right is not set by said setting mechanism, not executing said predetermined command in response to the request by said request mechanism.

7. The controlling device according to claim 6, wherein said setting mechanism comprises:
a computer readable medium containing a list of candidate controlling devices, said list including identifications of a set of a plurality of controlling devices that responded in order to a communication acknowledge signal from the controlled device; and
a selection mechanism, as said particular controlling device, configured to select a highest priority device of said plurality of controlling devices that is written as a highest order entry in the list, but if said highest priority device is not communicating with said controlled device, said highest priority device is deleted from the list, and a next highest priority device is selected from the list as said particular controlling device.

8. The controlling device according to claim 6, wherein said communications link is a wireless communications link.

9. The controlling device according to claim 7, wherein said identifications include Internet protocol (IP) addresses.

10. The controlling device according to claim 6, wherein said predetermined command is a channel switching command.

11. A control method comprising the steps of:
establishing a communications link between a controlled device and one of a plurality of controlling devices;
executing control over said controlled device by a predetermined command dispatched from one of said plurality of controlling devices to said controlled device via said communications link;
requesting the predetermined command be dispatched to said controlled device;
setting a control right to a particular one of said plurality of controlling devices; and
if said particular one of said plurality of controlling devices is set to have the control right, executing said predetermined command in response to the request in said requesting step and, if said particular one of said plurality of controlling devices is not set to have the control right, not executing the predetermined command in response to the request in the requesting step.

12. The control method according to claim 11, wherein said setting step comprises:
storing in a memory a computer readable list of candidate controlling devices, said list including identifications of a set of the plurality of controlling devices that responded in order to a communication acknowledge signal from the controlled device; and
selecting, as said particular controlling device, a highest priority device of said plurality of controlling devices that is written as a highest order entry in the list, but if said highest priority device is not communicating with said controlled device, said highest priority device is deleted from the list, and a next highest priority device is selected from the list as said particular controlling device.

13. The method according to claim 11, wherein said establishing step includes establishing a wireless communications link.

14. The method according to claim 12, wherein said storing step includes storing Internet protocol (IP) addresses.

15. The method according to claim 11, wherein said requesting step includes requesting a channel switching command.

16. A computer readable medium containing instructions that implement a process, when executed by a processor, comprising steps of:
establishing a communications link between a controlled device and one of a plurality of controlling devices;
executing control over said controlled device by a predetermined command dispatched from one of said plurality of controlling devices to said controlled device via said communications link;
requesting the predetermined command be dispatched to said controlled device;
setting a control right to a particular one of said plurality of controlling devices; and
if said particular one of said plurality of controlling devices is set to have the control right, executing said predetermined command in response to the request in said requesting step and, if said particular one of said plurality of controlling devices is not set to have the control right, not executing the predetermined command in response to the request in the requesting step.

17. The computer readable medium of claim 16, wherein said setting step of said process comprises:
storing in a memory a computer readable list of candidate controlling devices, said list including identifications of a set of the plurality of controlling devices that responded in order to a communication acknowledge signal from the controlled device; and
selecting, as said particular controlling device, a highest priority device of said plurality of controlling devices that is written as a highest order entry in the list, but if said highest priority device is not communicating with said controlled device, said highest priority device is deleted from the list, and a next highest priority device is selected from the list as said particular controlling device.

18. The computer readable medium according to claim 16, wherein said establishing step includes establishing a wireless communications link.

19. The computer readable medium according to claim 17, wherein said storing step includes storing Internet protocol (IP) addresses.

20. The computer readable medium according to claim 16, wherein said requesting step includes requesting a channel switching command.
